(19) United States
(12) Patent Application Publication
(10) Pub. No.: US 2021/0038948 A1
(43) Pub. Date: Feb. 11, 2021

(54) MULTI LEATHERS (MATERIALS) INTEGRAL SWING BALL / DUO LEATHERS (MATERIALS) INTEGRAL SWING BALL

(71) Applicants: CHANDAN SHARMA, Ghaziabad (IN); PRAVEEN SHARMA, New Delhi (IN); UJJAWAL SHARMA, Baltimore, MD (US)

(72) Inventors: CHANDAN SHARMA, Ghaziabad (IN); PRAVEEN SHARMA, New Delhi (IN); UJJAWAL SHARMA, Baltimore, MD (US)

(21) Appl. No.: 16/125,681

(22) Filed: Sep. 8, 2018

(51) Int. Cl. A63B 37/14; A63B 37/12; A63B 69/00; A63B 37/06; A63B 43/00; B29D 99/00

(52) U.S. Cl. CPC A63B 37/14; A63B 37/12; A63B 69/0015; A63B 37/06; A63B 2225/01; B29D 99/0042; A63B 2037/125; A63B 2209/08; A63B 43/008

(57) ABSTRACT

This invention is associated with the sport of cricket in particular but not limited to and applicable to other sports and games as well where a ball is used to play. The invention relates that when a cricket ball having combinations of magnets inside with two different leathers (materials) or a combination of multi-leathers (materials) on the two hemispheres, is delivered by a bowler at a speed, an inherent swing is obtained, which is proportional to the difference in the resultant densities on the two hemispheres of the ball. The invention is aimed at providing a technology by which an inherent swing/drifted spin in the delivered ball is inevitably established which is irrespective of any seam positioning, other bowling skills, surrounding and pitch conditions.

### TECHNICAL FIELD OR FIELD OF INVENTION

This invention is associated with the sport of cricket in particular but not limited to and applicable to other sports and games as well where a ball is used to play. However, to bring out the novel concept in a more precise and deeper way, cricket is the sports and particularly the bowling aspect is the art which will most justify it. The invention is aimed at providing a technology by which an inherent swing/drifted spin in the delivered ball is inevitably established which is irrespective of any seam positioning, other bowling skills, surrounding and pitch conditions.

### BACKGROUND OF THE INVENTION WITH DRAWBACK ASSOCIATED WITH KNOWN ART

In conventional cricket ball used for bowling in a cricket match or an international cricket match, is primarily made up of the following components (regardless of the methods of manufacturing)
a) A core of cork, which is layered with tightly wound string
b) Covered by a leather case with a slightly raised sewn seam

In a top-quality ball suitable for the highest levels of competition, the covering is constructed of four pieces of leather of same type, but one hemisphere is rotated by 90 degrees with respect to the other. The “equator” of the ball is stitched with string to form the ball's prominent seam, with six rows of stitches. The remaining two joins between the leather pieces are stitched internally. Lower-quality balls with a 2-piece covering are also popular for practice and lower-level competition due to their lower cost.

With this conventional ball, the leather on both hemispheres is of the same material. This provides a symmetrical balance in the ball, in terms of equal density, mass, volume, weight etc across the two halves. Hence, a new ball of this kind is aerodynamically or more commonly mechanically balanced when not in motion.

However, when a ball is non-craftily bowled at a speed, it wobbles with respect to the seam. And, when a ball is thrown by a good first class or an international bowler aiming to swing the ball, the same is done with an art & craft that is with specialised bowling skills.

When the new ball is released with the seam at an angle to the initial line of flight, the ball swings in the same direction that the seam is pointing, this is conventional swing. So a ball released with the seam angled towards the slip fielders will swing away from the batsman (outswinger) and one released with the seam pointed towards fine leg will swing into the batsman (inswinger). However, there are other types of swing also such as reverse swing and contrast swing etc, which together with the conventional swing, depends on various factors such as seam positioning, roughness/smoothness of the ball surfaces and bowling speeds. However not every bowler can swing the ball due to factors such as being less skilful or having a particular bowling action not suited for the same, or a defensive mind set of a bowler to ball a restrictive line of bowling only etc.

Moreover, at this day & age, the contest between Bat & Ball has been continuously becoming a biased affair. This has been mainly due to the following reasons such as advancement in bat manufacturing technologies which are producing more advanced and effective bats, non-advancement in ball manufacturing technology, batsmen friendly conditions in Indian sub-continents & also in some other countries where historically this was not the case earlier, some bowling restrictive rules and so on.

Due to this the quality of swing bowling has been going down and therefore needs a timeline breakthrough which could well be achieved by a technological marvel in the field of bowling.

Refer US patent no U.S. Pat. No. 5,280,906, Pasquale M Vitale, describing construction of various types of balls utilizing various aerodynamically rougher surfaces by intersecting grooves, to provide trajectory of the ball in a deflecting way.

The sports training ball mentioned in U.K. Patent GB2314778, (GRIFFIN SIMON WILLIAM), only describes innovative features to the outer surfaces or covers of the ball to provide desired inherent swing.

All the prior arts mentioned above and others currently known, provide desired and controlled deviation in air or from the pitch, with only fixed overall mass of the ball after it is manufactured, with no provision of a time dependent, dynamically, gradually, theoretically changing (or practically

although minutely) changing overall mass of the ball, inherently by using a set of duo-coupled dissimilar magnets part of the core and manually by Advanced High Precision Injection Moulding Facility to attain the required imbalance or balance of weight instantly depending upon requirement in sports or in the trainings.

OBJECT OF INVENTION

The object of invention is to achieve an inherent swing/drifted spin which is inevitably established in the delivered ball, irrespective of any manner in which the seam of the ball is positioned while delivering the ball, roughness of ball surface, speed at which the ball is delivered, surrounding and pitch conditions.

DISCLOSURE OF INVENTION OR STATEMENT OF INVENTION

The invention states that when a cricket (sports) ball having two halves or a single complete spherical ball or a ball with numerous homogeneous or heterogeneous parts, mandatorily having a pair of dissimilar spherical sectants permanent magnets attached to the already matched cut cork, on either halves of the cork, producing differential weights on either sides and consequently differential magnetic field energy, both would invariably be dynamically time dependent & hence producing

time dependent dynamically varying resultant differential mass inside due to the magnets, when in play, with additional resultant differential weight physical features on one of the halves or a particular portion of the entire ball, when thrown in air by a bowler at a speed in the field of cricket or any other sports, will have an inherent distinct characteristics or resistances to the prevailing physical forces acting on to the ball resulting in an inherent swing or deviation, which is

proportional to the difference in the resultant densities/weights on the two hemispheres of the ball or various separate portions of the ball. This resultant deviation due to this feature in the air or off the playing pitch shall be towards the heavier side or heavier portion of the ball. The overall resultant heaviness of the ball on one side or on one portion of the ball, is dynamic as it is time-dependent due to time-dependent dynamic resultant differential mass created inside by the magnets as due to the gradual wear n tear of the ball.

This inherent swing developed will be irrespective of the seam positioned while delivering the ball, roughness of ball surface, speed at which the ball is delivered, surrounding and pitch conditions.

### A SUMMARY OF INVENTION

A summary of invention is that for a cricket (sports) ball having mandatorily a pair of dissimilar spherical sectants permanent magnets attached to the already matched cut cork, on either halves of the cork with additional resultant differential weight physical features on one of the halves or a particular portion of the entire ball , delivered by a bowler at a speed, an inherent swing will be obtained, which is proportional to the difference in the dynamic resultant densities/weights of the two hemispheres of the ball or on separate portions of the ball.

### BRIEF DISCRIPTION OF THE ACCOMPANYING DRAWINGS

Let there be different types of leathers on the two hemispheres of the ball having a pair of dissimilar spherical sectants permanent magnets attached to the already matched cut cork, on either halves of the cork for simplification. And let the basic arrangement be as shown in FIG. 1 below.

The two leathers of different type with their ends stitched together having the conventional seam is also shown in FIG. 1.

The Hemisphere on the left side is made up of a leather type A and on the other side is made up of leather type B. These two leathers will definitely have different densities, deliberately selected to have appreciable difference, this confirms that there will be different levels of porosity also, that is they will have different packing density. The volume of leathers used on both sides is same, hence their masses would be different. Also as a pair of dissimilar spherical sectants permanent magnets are mandatorily attached to the already matched cut cork, on either halves of the cork, inside of the ball, producing differential weights on either sides and consequently differential magnetic field energy, both would invariably be dynamically time dependent & thus finally producing an overall time dependent dynamically varying differential magnetic field mass. Now, when the ball is bowled at a certain velocity, both the halves will have the same velocity since they are stitched together, thus the momentum imparted on the sides are different and hence according to Newton's Second Law of Motion, the developed forces on the two sides would also be different. These dissimilar forces, developed on either side, impart different degrees of opposition/support to the prevailing or natural forces (such as drag

force, lift force, side force etc) acting on a moving ball. Hence, an inherent differential resultant force would surely try to drift the ball in a certain direction.

FIG. 1 : Describes as above, the basic representation of the Duo Leather Cricket Ball along with Inside arrangement of Duo-coupled Magnets

FIG. 2: Describes the basic representation of the forces acting on a cricket ball

FIG. 3: Describes example of Fast bowling with Backspin/Backward spin/Anticlockwise Spin with ball moving forward

FIG. 4: Describes Forces and their components acting on the ball when travelling in air

FIG. 5: Describes Centre of Mass of the Duo Leather Ball

FIG. 6: Describes Resultant Force at A

FIG. 7: Descries Resultant Force at B

FIG. 8: About Swing Type 5

FIG. 9: Illustrates Outswing with heavier half ‘B’ on right side

FIG. 10: Illustrates Inswing with heavier half ‘B’ on right side

FIG. 11: About Swing Type 14

FIG. 12: Shows Swing Type 1

FIG. 13: Shows Swing Type 3

FIG. 14: Illustrates various Multi Leather Cricket Ball with Duo Coupled Magnets configurations

FIG. 15: Illustrates Resultant magnetic fields/forces 152 shown as a result of the Duo-Coupled

magnets that shall be limited to within the ball itself so as not to influence any metallic objects outside. The same is also having artistic feature shown as 151.

FIG. 16: Describes various other Innovative Cricket Ball configurations as described in these specification/claims with various Duo Coupled Magnets configurations, also showing with Advanced Injection Moulding Technique being used in FIG. 16.B. Here the injection apparatus

design is out of the scope of this specification.

FIG. 16.A shows an innovative ball with greater number of seams on one side than other and 161A & 162A shows two different magnets attached together on one side and 163A single curved magnet on other side.

FIG. 16.B shows an innovative with seam on one side only also having facility to have Advanced

Injection Moulding technique on other side through tiny holes into the inner core putting fluids of various molten non-viscous type into the void spaces 161B, 162B, 163B. 164B shows the apparatus that is used to inject the same.

FIG. 16.C shows an innovative ball with 161C shows one half with slight circular grooves.

FIG. 16.D shows an innovative ball with a combination of 6 magnets designated as 161D, 162D, 163D, 164D, 165D, 166D combined together to form a single magnet and two magnets designated as 167D, 168D to form a single magnet on the other side

FIG. 16E shows an innovative ball having seam not in the middle but slightly offset towards left.

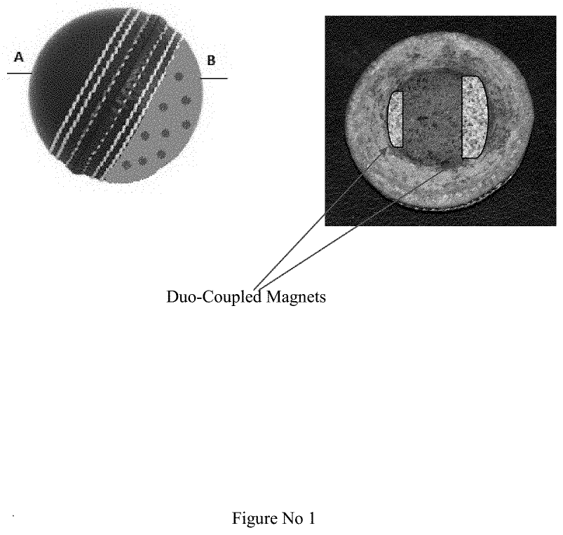

The ‘N’ & ‘S’ marked near the magnets in the above drawings are ‘North Pole’ & ‘South Pole’ respectively. The other configuration in braces that is (S) & (N) below ‘N’ & ‘S’ is also possible.

### MODE(S) FOR CARRYING OUT THE INVENTION OR A DETAILED DISCRIPTION OF THE INVENTION

As already briefly explained above, let there be such a special innovative cricket (sports) ball, which is primarily made up of the following components (regardless of the different methods of manufacturing currently prevalent in the world)
a) A core of cork with mandatorily a pair of dissimilar spherical sectants permanent magnets attached to the already matched cut cork, on either halves of the cork, which is layered with tightly wound string, producing differential weights on either sides and consequently differential magnetic field energy, both would invariably be dynamically time dependent & hence producing time dependent dynamically varying resultant differential mass inside due to the magnets, when in play, having two halves or a single complete spherical ball or a ball with numerous homogeneous or heterogeneous parts with additional resultant differential weight physical features (as described below) on one of the halves or a particular portion of the entire ball
b) Covered by two different leather covers (for simplification), stitched together with a slightly raised sewn seam. This basic innovative ball features shall be extended in various other combinations such as:
   i) Top cover fabrication out of various leather (materials) types stiched
   ii) Different orientations of the leathers (materials),
      iii) Amount of the types of leathers (materials),
      iv) The nature of leathers (materials) and
         The specialised inner core having different types, orientations, amount of the materials used for the different portions of the sub-components such as thread, cushions, cork (wood, fibre, metal, metal alloys etc), any other fill material etc which are used to make that inner core along with the swen seam material (thread) with various different types, orientations, amount (count) of the materials used for the different portions

The innovative ball shall have additionally provision for a very special feature called as ‘Advanced High Precision Injection Moulding Facility’ that as per requirement of the bowling side in a game or during the training schedule will allow high precision injection of various types of materials such as:

thermoplastics,

thermosetting plastics,

elastomers,

polymers,

alloys etc

in liquefied or gaseous or plasma state (a non-viscous) through the tiny, micro or nano level holes already being made on one half or both halves (wherever hemispheres of ball will have tiny holes) into the void spaces within the leather itself, or between the leather (outside cover) & the inner core or into the void spaces inside the inner core itself. This injected material shall solidify to form small lumps inside the void spaces to attain the required imbalance or balance of weight instantly (a dynamic instantaneous unbalancing or balancing feature depending upon requirement) so as to obtain the required swing, drift etc in order to balance the competition between the innovative ball and bat in a match. However the apparatus to inject the materials is out of the scope of this invention.

The invention brought out for the ball, shall be understood in general terms in the same way and shall be proportionally applied /interpolated to various other material configurations than leathers, being stiched on various portions, hemispheres of the ball, similarly also further applying to the specialised inner core & swen seam materials respectively.

The permanent magnet sectants attached to the cork shall be of any type such as Alnico, Neodymium Iron Boron, Samarium Cobalt, Ceramic or Ferrite etc. or combination of these types or combination of other various magnetic materials. These permanent magnets may be ferromagnets or ferrimagnets or the lighter intensity magnet may be temporary magnets also. But for sports purpose high profile magnets such as NdFeB, SaCo etc having high magnetic field strength may not be used. The orientation and selection of two magnets shall be such, that complete assembly does not create magnetic field that influences metallic objects outside the ball, that is North Pole of one shall face North Pole of another or South Pole of one shall face South Pole of another and accordingly choosing their strengths as well. However net small resultant differential magnetic field energy or mass inside is surely required to serve the time dependent dynamic magnetic field energy or mass factor. The innovative ball may use different lacquers (white, pink or red or other etc) on any of the different leather (material) types being stitched on the ball as per the requirement. These leathers being used may have various types of embedded and articulate designs to an extent that will not hinder the natural bounce that is required in particular sports.

The embedded designs would include

but shall not be limited to

pin (tiny) holed design,

spotted design (protruded),

spotted design (apertured),

zig-zag design,

combed design,

tiny fins design,

webbed design,

other geometrical figure designs made on the/with the leathers to produce additional imbalance features. These types of design shall also be applicable for the inner core components or swen seam. The articulate designs may also be implanted either in a protruded way or inscribed (aperture) way, generally would also include graphics, sketches, photos, images etc being similarly printed on the leathers (materials) for further artistic appeal & imbalance features. However the trade-off factor as described below needs to be taken into account while manufacturing the ball as these designs will affect both mass and roughness at the same (that is drag coefficients as well as side coefficients). These embedded and articulate designs on either halves may be different in quantities, size etc.

Now Deviation in air due to aerodynamics created by the roughness or smoothness of the finished covers depending on the ISO Roughness grade number plus inherent texture of the outer surfaces i.e molecular level smoother surface or rougher surface which depends upon the molecular packing density of the type of Leathers (materials) used and will invariably be related to the weight of the hemispherical covers or hemispheres plus the speed at which same is bowled. Hence while talking about overall surface roughness or smoothness, the roughness or smoothness of the finished cover plus the inherent texture of the outer surfaces needs to be taken into account. In this view there is a slight trade-off that exists between overall roughness value and overall weight value of the cover and accordingly needs to be considered in the force balance equation and accordingly proceed for manufacturing of the ball as per the requirement.

Deviation from the playing pitch due to differences of weights on the two hemispheres or differences of weights of different portions of a single spherical ball shall be towards the heavier portion of the ball.

The technical features being used in bringing out the innovative ball, thereafter being extended and understood, shall also be applicable when the same features are being used into the formula or an algorithm or a computer programming which shall be part of the bowling or playing schemes in respective sports' video games, High Definition games, mobile games, internet games, etc being used or will be made in future in gaming industry

The technical features being used for the innovative ball are such that, which are already mentioned and proven in the description, shown applicable to macroscopic scale of physical systems (means such systems i.e sports balls, which can be easily seen through the human eyes without additional aids such as a microscope & or a nanoscope. The same features and their benefits shall also be applicable in the microscopic physical systems (which are seen only with the help of a special microscope or a nanoscope) such as in Nanotechnology. The resulting desired deviation shall depend on the same features as mentioned however to an extent, depending upon the physics or laws that exist at such a micro/nano level. The innovative ball or the method as described above shall also hold when executed on other celestial bodies apart from earth such as on moon, mars, europa etc depending on the value of acceleration due to gravity on respective surfaces.

The detailed description and technical specifications that are in support of the invention are as given below: This innovative cricket (sports) ball having two halves or a single complete spherical ball or a ball with numerous homogeneous or heterogeneous parts, mandatorily having a pair of dissimilar spherical sectants permanent magnets attached to the already matched cut cork, on either halves of the cork, producing differential weights on either sides and consequently differential magnetic field energy, both would invariably be dynamically time dependent & hence producing time dependent dynamically varying resultant differential mass inside.

Let us bring out how this duo coupled dissimilar spherical sectants permanent magnets attached to the already matched cut cork, produce the resultant differential magnetic field mass. The Magnetic field produce by a sphere at a distance Z from the sphere surface at the symmetrical axis is

B=2/3 Br×(R/R+Z)̂3.

Br: Remanence field, independent of the magnet's geometry

Z: Distance from the sphere edge on the symmetry axis

R: Semi-diameter (radius) of the sphere

Now while manufacturing this innovative ball, attachment of the larger/heavier spherical sectant magnet out of the two dissimilar spherical sectant magnets, shall be on that side which the manufacturer wants to make it heavier with other additional physical features part of either rest of the core or cover or swen seam.

As per above since leather type B on right side having density D2 is more heavier than leather type A on left side having density D1, hence larger spherical sectant magnet shall be attached to the core on the right side. And accordingly the smaller spherical sectant magnet shall be attached to the core on the left side. Now it is logical and from the formula mathematically corrects to say that larger magnet shall produce greater magnetic field at the same distance than a smaller magnet at the same distance. Let that magnetic field produced by right side magnet be B2=KbBr×(Rb/Rb+Z)̂3 and by left side be B1=KaBr×(Ra/Ra+Z)̂3. ‘Ka or Kb’ is a factor <1, to take into account geometrical factor for the spherical sectant. Now since Rb >Ra and Kb >Ka for larger magnet, B2 shall be greater than B1. However since both magnets shall be placed in such a way that complete assembly does not create magnetic field that influences objects outside the ball, that is North Pole of one shall face North Pole of another or South Pole of one shall face South Pole of another. Hence the net magnetic field could be assumed to be produced by a ring type spherical sectant on the right side and same shall be approximated to be the difference of B2 & B1. However the magnetic field at a distance Z from a ring type spherical sectant at right side could be approximated to be

Bb=KBr/2[(D+Z)/√{Râ2+(D+Z)̂2}−Z/√{Râ2+Ẑ2}−(D+Z)/√{Rî2+(D+Z)̂2}−Z/√{Rî2+Ẑ2}

Br: Remanence field, independent of the magnet's geometry (see physical magnet data)

Z: Distance from a pole face on the symmetry axis

D: Thickness (or height) of the ring

Ra: Outside radius of the ring

Ri: Inside radius of the ring

K: factor supporting that the ring is slightly spherical shaped

The energy stored in a magnetic field is E=1/2 B̂2/μ where μ is the Magnetic Permeability of the medium in which magnetic fields are created and this energy decreases as the distance increases from the spherical magnetic ring type. Now according to Mass Energy Balance equation, E=MCÂ2, that provides an information that Mass is associated with magnetic field energy and it also decreases as the distance increases. Now as on right side weighs more and magnetic field mass produced by the resultant spherical ring type magnet decreases with distance, hence it could be derived that right core inside has more mass than left side pertaining to the resultant magnetic effect. Now the mass of the inside components plus magnetic field energy or mass created, used inside the leather covers are also different, let it be M1′ & M2′ respectively for left side & right side with M2′>M1′. Also this small resultant magnetic field energy or mass created inside depends upon various physical attributes of the magnets such as dimensions, shape etc. These attributes starts decreasing over the time due to gradual wear & tear of the magnets because of frictions between physical contacts with the cork arising out of various regular & sudden physical impacts with the pitch, bat, ground, boundary, stadium concrete or steel structures, advertising hoardings etc. Thus the resultant magnetic field energy or mass starts decreasing with time, making the magnetic field energy or mass dynamic that is time dependent. And thus with additional resultant differential weight physical features on one of the halves or a particular portion of the entire ball, the entire ball has a dynamic time dependent resultant differential weight feature.

Now lets us describe how the additional resultant differential weight physical features on one of the halves or a particular portion of the entire ball could affect the inherent deviation.

The Hemisphere on the left side is made up of a leather type A and the hemisphere on the right side is made up of a leather type B. These two leathers will definitely have different density, which is selected in such a way to have an appreciable difference between them. They will have different levels of porosity in themselves which is natural to different leathers. Thus they have different packing density also, less dense will have less and vice versa. The volumes of leathers used on both sides are same because the thickness and the surface area are same on both sides. The masses of leathers on both the sides would then be different, whereas the masses of other components used beneath the covers on either side are supposed to be same and hence, the overall mass of one hemisphere becomes greater than the overall mass of the other hemisphere. Now, when the ball is bowled a certain velocity, the momentum given on the sides are different and hence according to Newton's Second Law of Motion, the developed forces on the two sides would be different. These dissimilar forces, developed on either side, impart different degrees of opposition/support to the prevailing or natural forces (such as drag force, lift force, side force etc) acting on a moving ball. Hence, an inherent differential resultant force would surely make the ball drift in a certain direction.

Let the density of leather A be D1 and density of leather B be D2 where D2 >D1. The leather A will have more number of pores per unit volume than leather B because of less packing density. Leather A has more pores per unit volume and hence will have less no of grains per unit volume and similarly vice versa for Leather B. This indicates that Leather B has more structural strength in terms of grains packing and hence will be stronger, stiffer and tougher to get any deformation as compared to Leather A. In this case, leather A (less dense) will deform much faster and hence as time passes will be the rougher side. The pores at leather B in the micro level looks like negative roughness that is like troughs, which is more in numbers as compared to Leather A and hence will be the probable rougher side when the ball is new. Hence leather A will have more roughness than leather B inherently. The volume of the leathers used on both sides will be same as explained above.

Hence, mass of the leathers on side A and B are calculated as below:

M1= [symbol] ×D1

M2= [symbol] ×D2

Where M1 & M2 are the mass of the leathers on side A & B respectively and [symbol] is the volume of the leathers used on each side. Hence M2 will come greater than M1.

Now the mass of the components plus magnetic field energy or mass created, used inside the leather covers are also different, let it be M1′ & M2′ respectively with M2′>M1′ as explained above and hence the total mass on side A is M1+M1′ and on side B is M2+M2′. Thus, it is inferred that M1+M1′<M2+M2′. Now let the total mass on left hand side of the ball be Ma=M1+M1′ and on the right hand side be Mb=M2+M2′, where Ma<Mb.

Suppose the ball is bowled at an initial velocity “Vi”, hence, the momentum developed on the left hand side half would be Pai=Ma×Vi and the momentum on the right hand side half would be Pbi=Mb×Vi.

Here, Pbi >Pai as per the above calculation. However, these are initial momenta being generated by the force Fi exerted by the hand of the bowler at the time of delivery, t=0.

Initial conditions could be summarised as follows:

a) Total momentum Pi=(Ma+Mb) Vi

b) Total force exerted Fi=(Ma+Mb) Ai Where Ai is the initial acceleration.

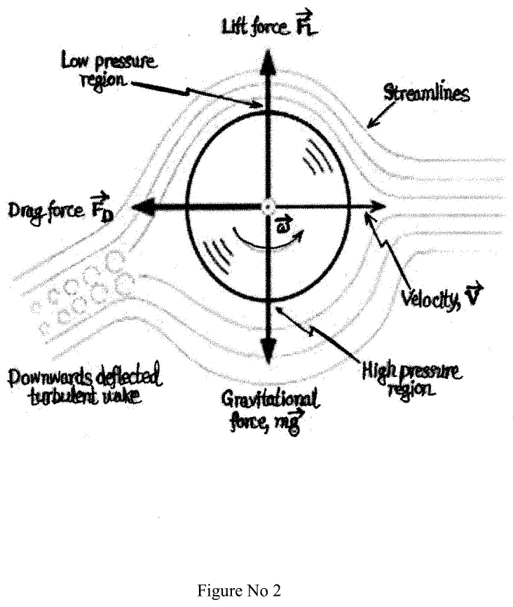

In due course, while ball being in the flight with velocity V and angular velocity ω but before hitting the pitch, there are number of external forces acting on the ball. These are the forces which are being represented in the following FIG. 2:

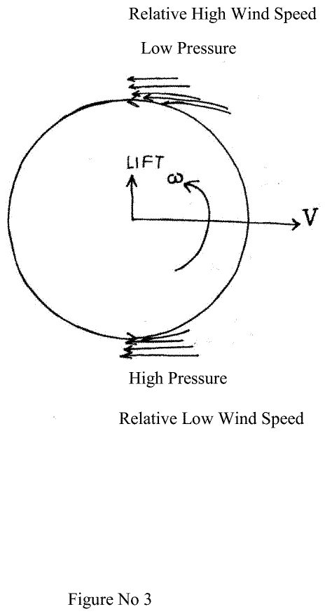

From the figure it is understood that there are three types of forces acting on the ball namely lift force (upward direction) Fₗ, gravitational force (downward direction) mg and drag force (Backward direction) F_{d}. Also to note that, first of all we are considering fast bowling aspect, hence this is a case of backspin/backward spin/anticlockwise spin angular velocity ω on the ball with ball moving forward with velocity V as can be seen from the FIG. 3:

Here it can be observed that at the up side the relative wind velocity is higher (with low air boundary layer pressure) and at the down side the relative wind velocity is lower (with high air boundary layer pressure), hence due to this differential pressure there is an upward lift force on the ball.

In contrary to this, in case of spin, there is top spin/forward spin/clockwise spin on the ball with ball moving forward and hence there is a downward lift force.

A fluid flowing past the surface of a body exerts a force on it. Lift is the component of this force that is perpendicular to the oncoming flow direction.

It contrasts with the Drag force, which is the component of the surface force parallel to the flow direction but opposite the same.

If the fluid is air, the force is called an aerodynamic force.

Drag depends on the properties of the fluid and on the size, shape, and speed of the object. One way to express this is by means of the drag equation:

F_{D}=1/2ρν²C_{D}A

Where F_{D} is the drag force,

ρ is the density of the fluid

ν is the speed of the object relative to the fluid,

A is the cross sectional area, and

C_{D} is the drag coefficient—a dimensionless number

The drag coefficient depends on the shape of the object and on the Reynolds number:

$${R}_{e} = \frac{υ D}{v}$$

where D is some characteristic diameter or linear dimension and ν if is the kinematic viscosity of the fluid (equal to the viscosity μ divided by the density).

The lift produced for specific flow conditions can be determined using the following equation

F_{L}=1/2ρν2 Ct A

where
F_{L} is lift force,
ρ is air density,
ν is true airspeed,
A is plan form area, and
Ct is the lift coefficient

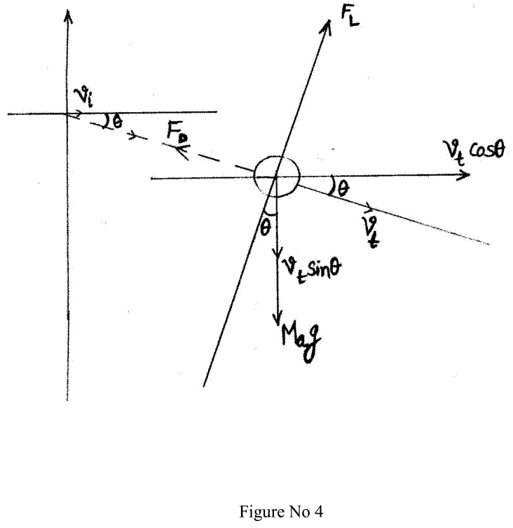

Note: Here as can be seen above that the drag as well as lift depends on the velocity of the object with which it is flying, and we know that this velocity is a function of distance which it has travelled that can be justified by assuming the effect of different forces in different directions. The work done by a force is the magnitude of the force times the component of displacement in the direction of the force. Gravity has only about two metres of downwards vertical travel over which to accelerate the ball, while the drag has about twelve metres (more for a slow bowler) to decelerate it. Consequently, drag has a greater effect on reducing the kinetic energy (and thus slowing it) than has gravity in increasing it. Also it shall be noted that while mentioning above equations of drag and lift, we have assumed that the air is still with insignificant movement and hence when the air itself starts moving which is very unpredictable in terms of its magnitudes and directions, will have an unpredictable wind velocity factor to be considered against the velocity of ball itself. This air/wind velocity in turn depends on various factors such as the latitudes of location, elevation of location, season of the year, weather conditions such as sunshine, temperature, humidity and also on the geometrical shape of the stadium itself in which the play is on which in turn can allow or hinder the flow of wind inside the stadium etc which makes the equation even more complex. The purpose for which this specification is brought out does not need such a precise calculation considering the wind velocity factor, however complex it may be, as the same will be cancelled and hence such a factor only remains a formality. Let that wind velocity factor be “K”. Now let us draw a figure, FIG. 4 as given below, indicating different forces and their directional components with symbols and signs as indicated are depicted above/below in the force balance equations:

We have also a case here, where it is important to calculate the resultant position of centre of mass of the new ball. The ball is divided into two halves as we can see in earlier figures where each half having hemisphere leather shell encompassing a hemisphere cork core inside the ball.

The centre of mass of a hemisphere (placed on a flat horizontal plane with flat face placed on the plane) of radius r is 3r/8 inside the body from the centre on the vertical symmetrical axis. But since there is a hemispherical shell encompassing the half core, the effective position of centre of mass on both sides shall be very slightly more or less inside the hemisphere depending on the differences in the densities of shells and cores respectively on both sides, and that extra distance will be proportional to the differential densities between the shells and the cores respectively on both sides.

Hence, lets us take the approximate position of centre of mass of the halves A & B as 3r/8 & 3r′/8 respectively.

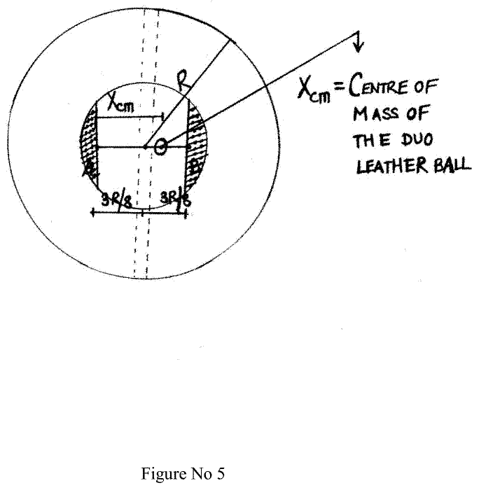

Let us consider that Ball has a radius of “R” and the FIG. 5 below describes the geometry of the same for finding the resultant centre of mass of the new ball:

Now we know that mass of half A is Ma and B is Mb. Let us take as shown above point A as the reference point for calculation of resultant centre of mass of the entire ball. The formula for calculating the centre of mass is as given below

$$\begin{matrix}Xcm = Mb \times 2 ( 3 R / 8 ) / ( Ma + Mb ) \\ = 3 / 4 R \times ( Mb / Ma + Mb )\end{matrix}$$

Now Mb/Ma+Mb in this specification shall always be <1, hence Xcm shall always be <3/4 R and it is surely be greater than zero as R>0. Hence the resultant centre of mass shall always lie between zero and 3/4 R i.e between the two individual centre of masses of the respective halves. However since Mb>Ma and hence centre of mass will lie on the right side of the centre in half B as shown. And the extent to which it lies to the right depends on the magnitude of masses difference. Now let us consider forces at A and considering FIG. 4,

Ma×g−1/2 ρ (ν+K)2 C₁A cosΘ=Ma At sinΘ, in the downward direction

And −1/2 ρ(ν+K)2 C_{d} A cosΘ=Ma At cosΘ, in the forward direction

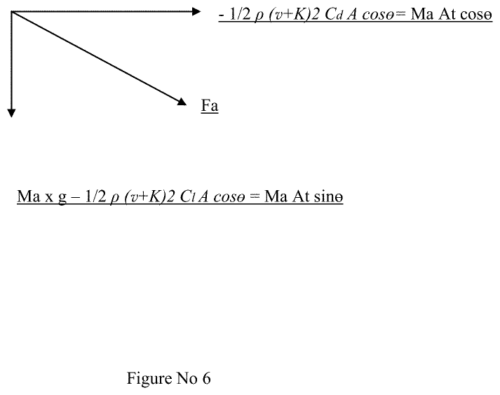

The resultant force at A will be as depicted below in FIG. 6:

Hence Fa is given by

$$\begin{matrix}Modulus of \vec{Fa} = \vert Ma \times At \vert \\ = √ ( Ma \times At ) 2 \{ ( cos θ ) 2 + ( sin θ ) 2 \} \\ = √ \{ ( Ma At cos θ ) 2 + ( Ma At sin θ ) 2 \} \\ = √ \{ ( Ma \times g - 1 / 2 ρ ( v + K ) 2 Cl A cos θ ) 2 + \\ ( - 1 / 2 ρ ( v + K ) 2 Cd A cos θ ) 2 \} from above\end{matrix}$$

Similarly forces at B and considering FIG. 4 above,

Mb×g−1/2 ρ(ν+K)2 CdA cosΘ=Mb At sinΘ, in the downward direction

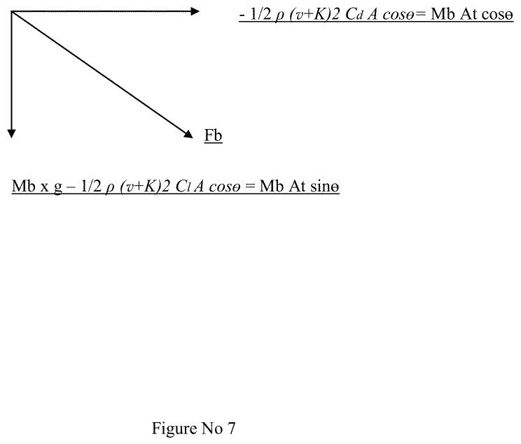

And −1/2 ρ(ν+K)2 CdA cosΘ=Mb At cose, in the forward direction The resultant force at B will be as depicted below in FIG. 7:

Hence Fb is given by

$$\begin{matrix}Modulus of \vec{Fb} = \vert Mb \times At \vert \\ = √ ( Mb \times At ) 2 \{ ( cos θ ) 2 + ( sin θ ) 2 \} \\ = √ \{ ( Mb At cos θ ) 2 + ( Mb At sin θ ) 2 \} \\ = √ \{ ( Mb \times g - 1 / 2 ρ ( v + K ) 2 Cl A cos θ ) 2 + \\ ( - 1 / 2 ρ ( v + K ) 2 Cd A cos θ ) 2 \} from above\end{matrix}$$

We know that Mb>Ma and hence we can conclude that

$$Modulus of \vec{Fb} > Modulus of \vec{Fa}$$

The net acceleration on half A is lesser than on half B. However, part B wants to accelerate more than part A in the same time, but since the two halves are stitched together they would not pull apart in the directions of the individual accelerations because for that you need a strong side forces which can pull apart the stitched parts. It is also to be noted that side forces as described below with the mathematical formulae are developed & come into the above equations only when there is a degree of comparative roughness on one side compared to another side and the speed at which the ball is bowled will indicate the direction of the resultant side force and hence the direction of swing as described in table given below.

However this force is of very minimal magnitude for pulling apart such a strong stitched portion but only helps in swinging the ball. Also the ball halves will move with the same velocity, but as there is a net acceleration on part B plus the centre of mass of the entire ball is shifted to the right of the geometrical centre of the ball on the symmetrical axis, the net acceleration will try to move the ball towards right and would be more on changing the velocity direction as compared to velocity magnitude because velocity is already decreasing due to drag and hence the ball will dip towards the area of hemisphere B (for a new ball bowled at nominal bowling speed), where the extent of dip would depend on the difference in the densities or roughness of the two sides. However, here we have still not considered the effect of the degree of inherent or extrinsic roughness on the two parts of the new or old ball which are as shown below in a very detailed tabular manner.

As the ball is flying through the air, a thin layer of air called the “boundary layer” forms along the ball's surface. The boundary layer cannot stay attached to the ball's surface all the way around the ball and it tends to leave or “separate” from the surface at some point. The location of this separation point determines the pressure, and a relatively late separation results in lower pressure on that side. A side force or swing will only be generated if there is a pressure difference between the two sides of the ball.

Now the boundary layer can have two states: a smooth and steady “laminar” state, or a time-varying and chaotic “turbulent” state. The transition from a laminar to a turbulent state occurs at a critical speed that is determined by the surface roughness; the rougher the surface the lower the critical speed. However, on a very smooth surface and at nominal speeds, a laminar boundary layer can be forced to turn turbulent by “tripping” it with a disturbance. The disturbance can be in the form of a local protuberance or surface roughness which adds turbulent eddies to the laminar layer and forces it to become turbulent.

The below chart will be called as the CPU Swing Chart. The direction of Swing as mentioned in the table is either right or left that is either right or left in the horizontal direction perpendicular to the playing pitch. Hence, whatever be the condition, as per table below an additional factor or force of conditional swing based on bowlers skills will have to be added or subtracted as the case may be.

| | | | Speed at | | |
|---|---|---|---|---|---|
| | | Leading side | which the | | |
| Ball | Position of | facing the | ball is | | |
| Condition | Seam | batsmen | bowled | Direction of Swing | Type of Swing |
| Old | Straight, | Seam itself | <70 mph | Towards Right | Contrast Swing- |
| | seam facing | | | Side (inswinger) | Swing type 1 |
| | the wicket | | | | |
| | Smooth side | | | | |
| | on the left | | | | |
| | Rough side | | | | |
| | on the right | | | | |
| Old | Straight, | Seam itself | <70 mph | Towards Left Side | Contrast Swing- |
| | seam facing | | | (outswinger) | Swing type 2 |
| | the wicket | | | | |
| | Smooth side | | | | |
| | on the right | | | | |
| | Rough side | | | | |
| | on the left | | | | |
| Old | Straight, | Seam itself | >70 mph | Towards Left Side | Contrast Swing- |
| | seam facing | | | (outswinger) | Swing type 3 |
| | the wicket | | | | |
| | Smooth side | | | | |
| | on the left | | | | |
| | Rough side | | | | |
| | on the right | | | | |
| Old | Straight, | Seam itself | >70 mph | Towards Right | Contrast Swing- |
| | seam facing | | | Side (inswinger) | Swing type 4 |
| | the wicket | | | | |
| | Smooth side | | | | |
| | on the right | | | | |
| | Rough side | | | | |
| | on the left | | | | |
| New | Seam angled | Smooth side | <70 mph | Towards Left Side | Conventional |
| | towards slip, | | | (outswinger) | Swing- Swing |
| | Smooth side | | | | type 5 |
| | on the right | | | | |
| | Probable | | | | |
| | Rough side on | | | | |
| | the left | | | | |
| New | Seam angled | Smooth side | <70 mph | Towards Right | Conventional |
| | towards fine | | | Side (inswinger) | Swing- Swing |
| | leg, | | | | type 6 |
| | Smooth side | | | | |
| | on the left | | | | |
| | Probable | | | | |
| | Rough side on | | | | |
| | the right | | | | |
| New | Seam angled | Probable Rough | <70 mph | Towards Left Side | Conventional |
| | towards slip, | side | | (outswinger) | Swing- Swing |
| | Probable | | | | type 7 |
| | Rough side on | | | | |
| | the right | | | | |
| | Smooth side | | | | |
| | on the left | | | | |
| New | Seam angled | Probable Rough | <70 mph | Towards Right | Conventional |
| | towards fine | side | | Side (inswinger) | Swing- Swing |
| | leg, | | | | type 8 |
| | Probable | | | | |
| | Rough side on | | | | |
| | the left | | | | |
| | Smooth side | | | | |
| | on the right | | | | |
| New | Whatever you | Whatever you | =80 mph | Mostly No Swing | Conventional |
| | choose | choose | | | Swing- Swing |
| | | | | | type 9 |
| New | Seam angled | Probable Rough | >80 mph | Towards Right | Reverse Swing- |
| | towards slip, | side | | Side (inswinger) | Swing type 10 |
| | Probable | | | | |
| | Rough side on | | | | |
| | the right | | | | |
| | Smooth side | | | | |
| | on the left | | | | |
| New | Seam angled | Probable Rough | >80 mph | Towards Left Side | Reverse Swing- |
| | towards fine | side | | (outswinger) | Swing type 11 |
| | leg, | | | | |
| | Probable | | | | |
| | Rough side on | | | | |
| | the left | | | | |
| | Smooth side | | | | |
| | on the right | | | | |
| New | Seam angled | Smooth side | >80 mph | Towards Right | Reverse Swing- |
| | towards slip, | | | Side (inswinger) | Swing type 12 |
| | Probable | | | | |
| | Rough side on | | | | |
| | the left | | | | |
| | Smooth side | | | | |
| | on the right | | | | |
| New | Seam angled | Smooth side | >80 mph | Towards Left Side | Reverse Swing- |
| | towards fine | | | (outswinger) | Swing type 13 |
| | leg, | | | | |
| | Probable | | | | |
| | Rough side on | | | | |
| | the right | | | | |
| | Smooth side | | | | |
| | on the left | | | | |
| Old | Seam angled | Rough side | >70 mph | Towards Right | Reverse Swing- |
| | towards slip, | | | Side (inswinger) | Swing type 14 |
| | Rough side | | | | |
| | on the right | | | | |
| | Smooth side | | | | |
| | on the left | | | | |
| Old | Seam angled | Rough side | >70 mph | Towards Left Side | Reverse Swing- |
| | towards fine | | | (outswinger) | Swing type 15 |
| | leg, | | | | |
| | Rough side | | | | |
| | on the left | | | | |
| | Smooth side | | | | |
| | on the right | | | | |
| Old | Seam angled | Smooth side | >70 mph | Towards Left Side | Conventional |
| | towards slip, | | | (outswinger) | Swing- Swing |
| | Rough side | | | | type 16 |
| | on the left | | | | |
| | Smooth side | | | | |
| | on the Right | | | | |
| Old | Seam angled | Smooth side | >70 mph | Towards Right | Conventional |
| | towards fine | | | Side (inswinger) | Swing- Swing |
| | leg, | | | | type 17 |
| | Rough side | | | | |
| | on the right | | | | |
| | Smooth side | | | | |
| | on the left | | | | |

Ball Condition

New: A brand new ball being in play for less than 0-25 overs Old: A ball in play for greater than 30 overs of play

Leading Face—The hemisphere of the ball that has the larger portion being towards the wicket

The side force is defined as S=0.5 Cs ρ p A Q2. Here Cs, ρ, A, Q2 are the side coefficient, air density, ball cross sectional area, total velocity of the ball relative to the air.

After many experimental data's collected for the actual cricket ball in wind tunnel, the side force coefficient shall be approximately coming to 0.25.

Also to note that this side force coefficient depends on the various factors such as angle of seam projection, surface roughness, Reynolds number etc.

Some of the above swing types are shown below with the pictorial representation and with some brief description.

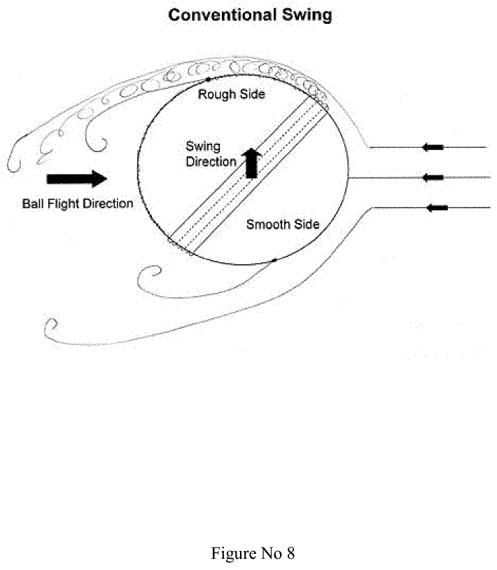

Refer above FIG. 8, between about 30 and 70 mph, the laminar boundary layer along the bottom surface separates at about the apex of the ball. However, the boundary layer along the top surface is tripped by the seam into a turbulent state and its separation is therefore delayed. This asymmetry results in a pressure differential (lower pressure over the top) and hence side force which makes the ball swing in the same direction that the seam is pointing (upwards).

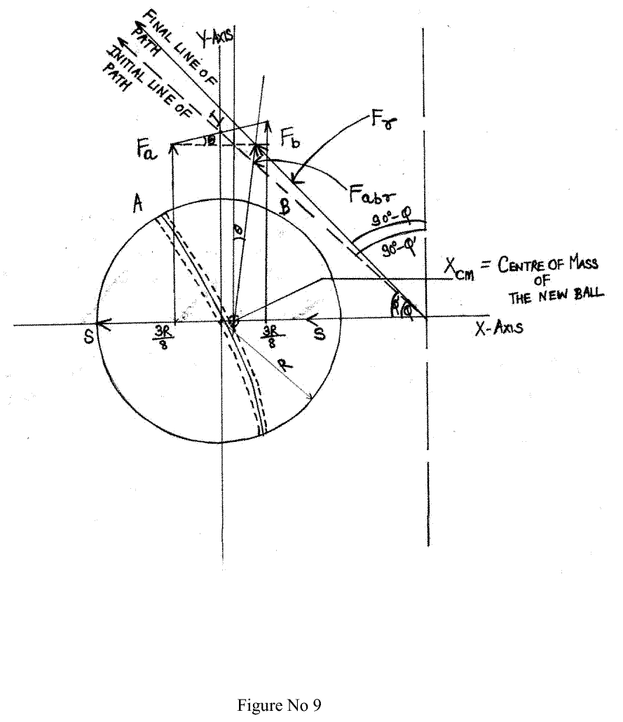

The direction of the net force or final path of flight will be as shown in the FIG. 9 below for the above swing type.

As can be seen from the above figure that the final line of path has a lesser angle with respect to the line of wickets when the bowler is trying for outswing and the heavier half B is on the opposite (right side).

This can be established in the following way, call the same as section P:

Let the orientation of the seam angle be as shown, with seam pointing towards slip, to deliver an outswing with side A on left side and side B on right side. Now the side force, S, developed, is as per the equation above. The forces developed in the two halves, acting separately, be Fa and Fb vertically down at an angle same as the flight of the ball. As already discussed, since Fb>Fa, the net acceleration of A will be lesser than that of B, that is in the same time, B will accelerate more than A, that is B will try to travel more than A, thus making a slight deviation/tilting towards B, shown by the line segment connecting Fa and Fb, making an angle Θ as shown. This is the line of deflection or deflected focal path in that period. However, the net force for the halves will have to be interpolated with respect to the new centre of Mass Xcm in the same manner as the deflected path such that this net force makes an equivalent angle to the vertical, Θ.

We know practically Θ will be very small and proportional to the weight differences of half B and half A and also to the distances travelled by B and A as can be seen from the figure itself. Now tan-1 (Θ) can be approximated to be equal to Fb−Fa/Fabr.

Now the side force S, as shown, can be traced back towards +X-AXIS, for vector addition with the resultant force Fabr. The resultant vector is the net force on the ball considering all the forces and will be termed as Fr making an angle φ with side force S.

Now let us again interpolate by considering that there was no weight differences between A and B. Then the centre of mass would not have been shifted to new position and also angle Θ would have been 0 (zero). Thus the net force would have passed through point I on the Y-AXIS with dashed line as shown. Let this force makes an angle φ′ with side force S. As can be seen that φ>φ′ and hence 90−φ<90−φ′.

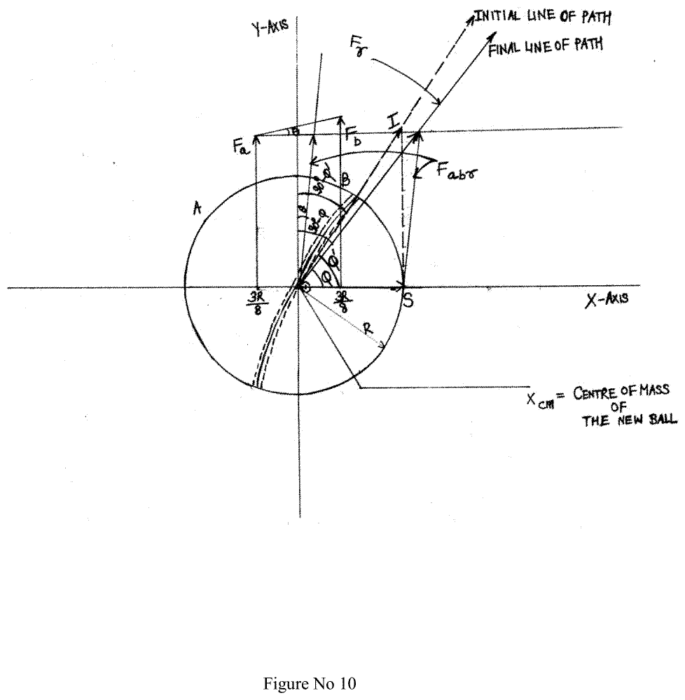

Hence, it can be seen that when the seam is pointed towards slip for outswing and heavier half B is on opposite side then there will be a reduction in the angle of outswing or the final line of path. In the same way it can be deduced that when the seam is pointed towards fine leg for an in swing and heavier half B is on the same side then there will be an increase in the angle of inswing or the final line of path as can be shown in FIG. 10.

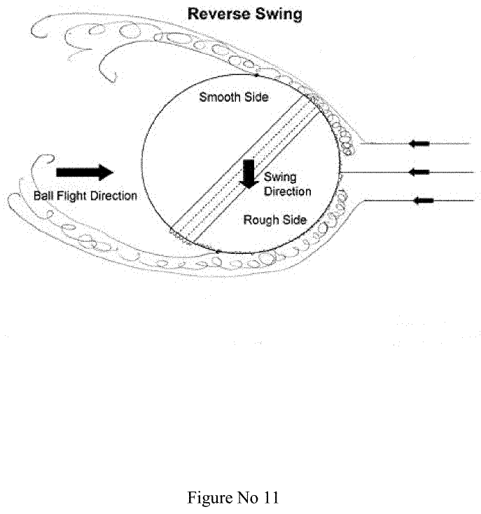

The flow over a ball exhibiting reverse swing is shown. So now, at a high enough bowling speed (over about 85 mph for a new ball) the laminar boundary layer transitions into a turbulent state relatively early, more importantly before reaching the seam location. In this case, the seam actually has a detrimental effect on the turbulent boundary layer by making it thicker and weaker and it therefore separates earlier than the turbulent layer over the bottom surface. As the roughness on this leading side (facing the batsman) is increased, the critical bowling speed above which reverse swing can be obtained is reduced. It also means that more effective reverse swing will be obtained at the higher bowling speeds. Refer FIG. 11.

Referring to the Section P above and considering that smoother side is the heavier side as side has more packing density and will be tougher to wear and tear. The other being less dense will be more prone to wear and tear and hence will be rougher. This is being explained already in the earlier sections. Here the side force is from B to A and heavier side B on opposite side, will thus reduce the angle of reverse swing.

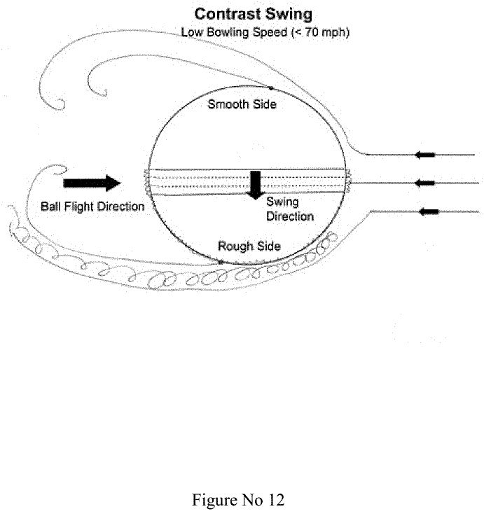

In FIG. 12, a ball with a contrasting surface roughness is flying through the air at a relatively low speed with the seam straight up. In this case, the boundary layer over the upper surface separates relatively early in a laminar state while that on the bottom rough side becomes turbulent and separates later. This asymmetry results in a side force which makes the ball swing towards the rough side. However since the smoother side is the heavier side, the extent of the swing will get reduced as per section P.

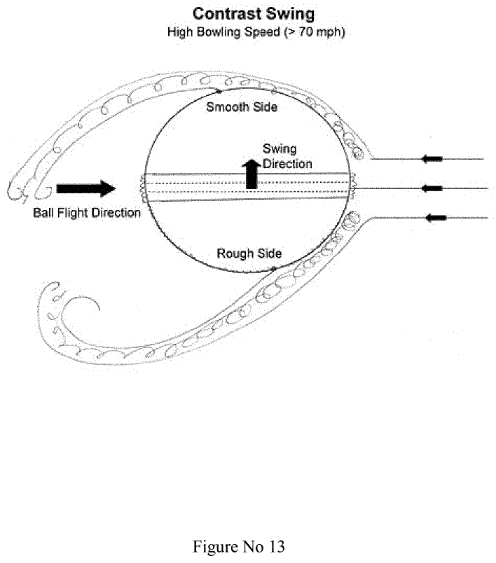

If the ball is released at a much higher speed, the flow field is different as shown in FIG. 13. In this case, transition occurs on both sides of the ball, but the turbulent boundary layer along the rough bottom surface is thickened and weakened (in the same way that the seam weakens the turbulent boundary layer in reverse swing). As a result the boundary layer on the rough side separates relatively early and the ball now swings towards the smooth side. However, since the smoother side is the heavier side, the extent of the swing will get increased as per section P in the above paragraph as shown.

This technical specification or explanation could well be extended for the multi leather cricket ball also in similar manners by inter-sketching each and every physical parameter proportionally to obtain a similar result.

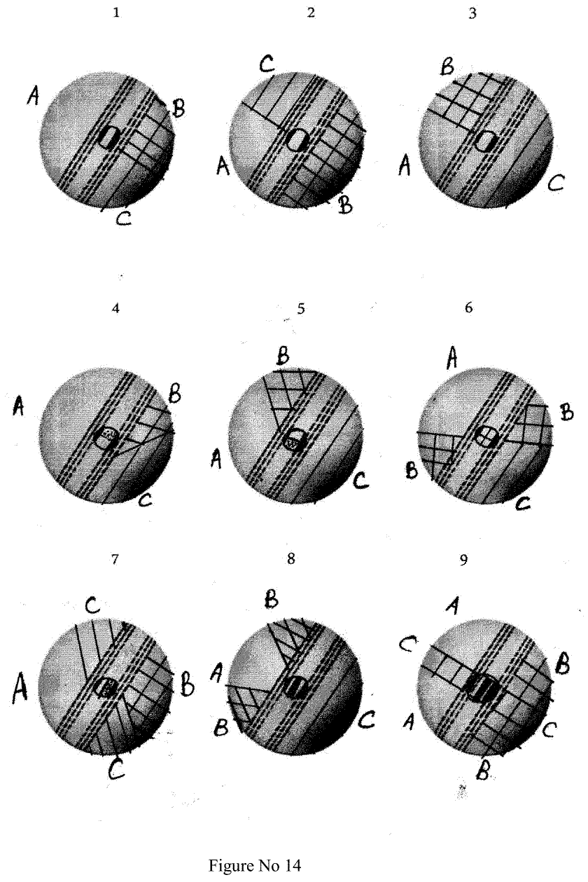

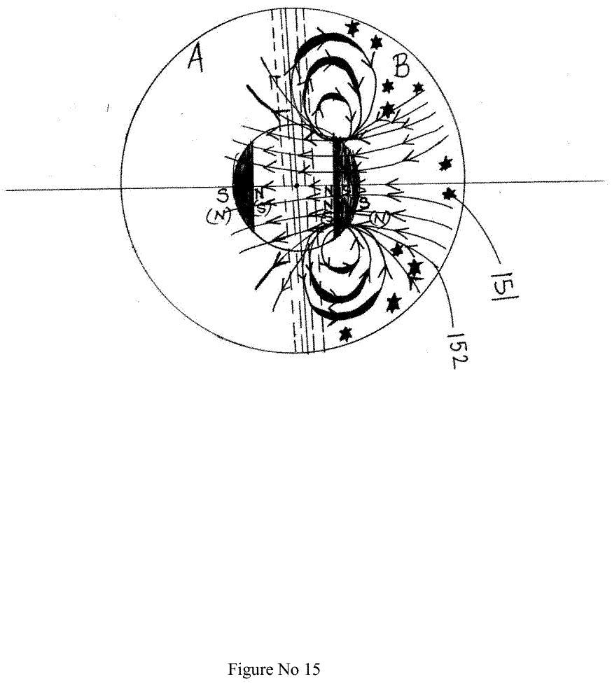

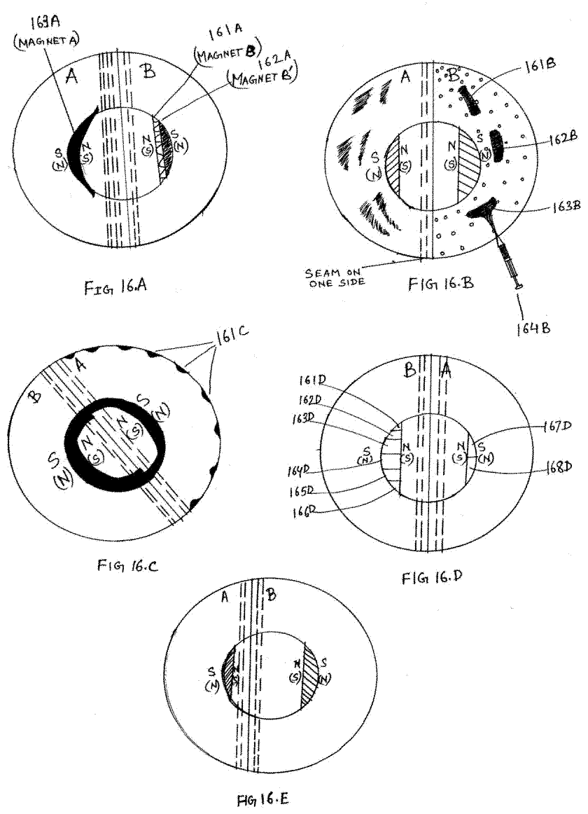

Some of the Multi Leathers cricket ball combinations have been shown in the FIG. 14. Here A, B & C designates different types of leathers. The drawing also shows the Duo-coupled magnets arrangement inside the core. Multi Leather Cricket Ball will also have the same inherent distinct characteristics or resistances to the prevailing forces, proportional to the orientation/location of stitching of various leather types and the amount of the types of leathers being used in making such an innovative ball.

All innovative ball configurations in FIGS. shown as 16.A to 16.E are typical only and other ball configurations as shown in other drawings shall also be consider typical only. However other ball configurations that are made out of these configurations combined in full together or part together or

with other configurations, all coming under the scope as defined in these specifications/claims shall also be consider part of this invention.

### INDUSTRIAL APPLICABILITY

This invention may be used in the field of sports for playing and particularly applicable to the sports gears/ball manufacturing companies to bring out such an innovative ball. This will balance the contest between the bat & ball in most of the sports much to the excitement of both the players and the spectators.

We claim that:

1. An Innovative Integral Swing Cricket (Sports) Ball having two halves or a single complete spherical ball or a ball with numerous homogeneous or heterogeneous parts, shall have mandatorily a pair of dissimilar spherical sectants permanent magnets attached to the already matched cut cork, on either halves of the cork, producing differential weights on either sides and consequently differential magnetic field energy, both would invariably be dynamically time dependent & hence producing time dependent dynamically varying resultant differential mass inside due to the magnets, when in play, with additional resultant differential weight physical features on one of the halves or a particular portion of the entire ball, when thrown in air in an act of bowling in the field of cricket or any other sports, will have an inherent distinct characteristics or resistances to the prevailing physical forces acting on to the ball, which shall be proportional to the weights of the hemispheres or weights of the various separate portions of the ball. The resultant deviation due to this feature in the air or off the playing pitch shall be towards the heavier side or heavier portion of the ball. The overall resultant heaviness of the ball on one side or on one portion of the ball, is dynamic as it is time-dependent due to time-dependent dynamic resultant differential mass created inside by the magnets. The need for bringing out this innovative ball is to make the balance between the competition of bat & ball, thus making the sports more competitive & interesting or making it used for the purpose of specialised training also.

2. This innovative ball in claim 1 shall have various physical features apart from the duo-coupled magnets attached to core such as:
Top cover fabrication out of various leather (material) types stiched;
different orientations of the leathers (materials);
amount of the types of leathers (materials);
the nature of leathers (materials) and the specialised inner core having different types, orientations, amount of the materials used for the different portions of the sub-components such as thread, cushions, cork (wood, fibre, metal, metal alloys etc), any other fill material etc which are used to make that inner core along with the swen seam material (thread) with various different types, orientations, amount (count) of the materials used for the different portions. These above factors are also a method or part of a method to determine the differences of densities between the shells & the cores on the two sides and thus the desired deviation, for manufacturing of innovative ball

3. The innovative ball in claims 1 & 2 combined, shall have additionally provision for a very special feature called as ‘Advanced High Precision Injection Moulding Facility’ that as per requirement of the bowling side in a game or during the training schedule will
allow high precision injection of various types of materials such as:
thermoplastics;
thermosetting plastics;
elastomers;
polymers;
alloys etc
in liquefied or gaseous or plasma state (a non-viscous) through the tiny, micro or nano level holes already being made on one half or both halves (wherever hemispheres of ball will have tiny holes) into the void spaces within the leather itself, or between the leather (outside cover) & the inner core or into the void spaces inside the inner core itself. This injected material shall solidify to form small lumps inside the void spaces to attain the required imbalance or balance of weight instantly (a dynamic instantaneous unbalancing or balancing feature depending upon requirement) so as to obtain the required swing, drift etc in order to balance the competition between the innovative ball and bat in a match.

4. The invention brought out for the ball in claims 1, 2 & 3 combined, shall be understood in general terms in the same way and shall be proportionally applied /interpolated to various other material configurations than leathers, being stitched on various portions, hemispheres of the ball, similarly also further applying to the specialised inner core & swen seam materials respectively as defined in claims 1,2,3 above. Then in addition to above & following with respect to the conditions mentioned in the CPU table as described in detailed description, following is claimed as a general statement:
“ In a Duo-Leather cricket ball (DLISWI) as defined in claims 1,2,3 combined, when is thrown by a bowler in air with the swen raised seam pointing towards slip position and resultant heavier half is on right side (considering effects of magnetic field mass & physical features) facing the batsman, then there will be reduction in the outswing (which would have happened if there were no dissimilarity between the weights on the two sides) and vice-versa, when the swen raised seam is pointing towards fine leg and heavier side is on right side, facing away from the batsman, then there will be increase in the inswing”.

5. The ball of claims 1, 2 & 3 combined deviates in the desired direction in one or more of the following ways:
Deviation in air due to aerodynamics created by the roughness or smoothness of the finished covers depending on the ISO Roughness grade number plus inherent texture of the outer surfaces i.e molecular level smoother surface or rougher surface which depends upon the molecular packing density of the type of Leathers (materials) used, and will invariably be related to the weight of the hemispherical covers or hemispheres plus the speed at which same is bowled. Hence while talking about overall surface roughness or smoothness, the roughness or smoothness of the finished cover plus the inherent texture of the outer surfaces needs to be taken into account. In this view there is a slight trade-off that exists between overall roughness value and overall weight value of the cover and accordingly needs to be considered in the force balance equation and accordingly proceed for manufacturing of the ball as per the requirement.
Deviation from the playing pitch due to differences of weights on the two hemispheres or differences of weights of different portions of a single spherical ball shall be towards the heavier portion of the ball.

6. The invention brought out for the ball in claims 1, 2 & 3 combined, shall apply not only to cricket ball but also to other balls of different
Sizes;
shapes;
materials;
being used in different sports such lawn tennis, table tennis, badminton, football, golf, baseball etc with cricket ball constituents being replaced by other constituent materials used respectively in those sports.

7. The innovative ball in claims 1,2 & 3 combined, may use different lacquers (white, pink or red or other etc) on any of the different leather (material) types being stitched on the ball as per the requirement. These leathers being used may have various types of embedded and articulate designs to an extent that will not hinder the natural bounce that is required in particular sports. The embedded designs would include but shall not be limited to
pin(tiny) holed design;
spotted design (protruded);
spotted design (apertured);
zig-zag design;
combed design;
tiny fins design,
webbed design;
other geometrical figure designs
made on the/with the leathers to produce additional imbalance features. These types of design shall also be applicable for the inner core components or swen seam. The articulate designs may also be implanted either in a protruded way or inscribed (aperture) way, generally would also include graphics, sketches, photos, images etc being similarly printed on the leathers (materials) for further artistic appeal & imbalance features. However the trade-off factor as described in claim 5 needs to be taken into account while manufacturing the ball as these designs will affect both mass and roughness at the same time (that is drag coefficients as well as side coefficients). These embedded and articulate designs on either halves may be different in quantities

8. The term leather (material) type being used for the innovative ball in claims 1,2 & 3 combined, means that only one type of leather (material) or a mixture (an alloy) of different leathers (materials) made it into one single leather or hybrid leather (hybrid material). The same may be natural or synthetic.

9. The permanent magnet sectants attached to the cork as defined in claim 1 shall be of any type such as Alnico, Neodymium Iron Boron, Samarium Cobalt, Ceramic or Ferrite etc. or combination of these types or combination of other various magnetic materials. These permanent magnets may be ferromagnets or ferrimagnets or the lighter intensity magnet may be temporary magnets also. But for sports purpose high profile magnets such as NdFeB, SaCo etc having high magnetic field strength may not be used. The orientation and selection of two magnets shall be such, that complete assembly does not create magnetic field that influences metallic objects outside the ball, that is North Pole of one shall face North Pole of another or South Pole of one shall face South Pole of another and accordingly choosing their strengths as well. However net small resultant differential magnetic field energy mass inside is surely required to serve the time dependent dynamic magnetic field energy or mass factor as defined in claim 1.

10. The innovative ball in claim 1 shall have larger/heavier magnet on that side which wants to be heavier as the resultant magnetic field energy or mass shall be more on that side only

11. The technical features being used in bringing out the innovative ball in claims 1,2 & 3, thereafter being extended and understood also for claim 4 above, shall also be applicable when the same features are being used into
the formula or
an algorithm or
a computer programming which shall be part of the bowling or playing schemes in
respective sports' video games; High Definition games;
mobile games;
internet games etc being used or will be made in future in gaming industry.

12. The technical features being used for the innovative ball in claims 1, 2 & 3 combined are such that, which is already mentioned and proven in the description, shown applicable to macroscopic scale of physical systems (means such systems i.e sports balls in claims 1 & 2, which can be easily seen through the human eyes without additional aids such as a microscope & or a nanoscope. The same features and their benefits shall also be applicable in the microscopic physical systems (which are seen only with the help of a Special microscope or a nanoscope) such as in Nanotechnology. The resulting desired deviation shall depend on the same features as mentioned in claims 1, 2 & 3 combined, however to an extent, depending upon the physics or laws that exist at such a micro/nano level.

13. The innovative ball or the method as described in the claims from 1 to 12 shall also hold when executed on other celestial bodies apart from earth such as on moon, mars, europa etc depending on the value of acceleration due to gravity on respective surfaces.
